(19) United States
(12) Patent Application Publication
(10) Pub. No.: US 2006/0134474 A1
(43) Pub. Date: Jun. 22, 2006

(54) Fuel cell humidification system

(75) Inventor: Akos Toth, Etobicoke (CA)

Correspondence Address: OGILVY RENAULT LLP, 1981 MCGILL COLLEGE AVENUE, SUITE 1600, MONTREAL, QC, H3A2Y3, CA

(73) Assignee: HYDROGENICS CORPORATION, Mississauga (CA)

(21) Appl. No.: 11/017,796

(22) Filed: Dec. 22, 2004

(51) Int. Cl. H01M 8/04

(52) U.S. Cl. 429/17; 429/25; 429/26; 429/39

(57) ABSTRACT

The present invention provides a fuel cell humidification system comprising features of a cathode humidification system, an anode humidity retention system and a countercurrent flow arrangement of the fuel and air streams in the fuel cell, which performs efficiently and is configured particularly for small fuel cells. The present invention further provides a simple method for controlling both cathode and anode humidification using the fuel cell humidification system of the present invention.

### FIELD OF THE INVENTION

The present invention relates generally to fuel cells, and more particularly relates to a fuel cell humidification system and a method used with the system for controlling both cathode and anode humidification.

### BACKGROUND OF THE INVENTION

Fuel cell systems are seen as a promising alternative to traditional power generation technologies due to their low emissions, high efficiency and ease of operation. Fuel cells convert chemical energy into electrical energy. Proton exchange membrane fuel cells comprise an anode, a cathode, and a selective electrolytic membrane disposed between the two electrodes. In a catalyzed reaction, a fuel such as hydrogen, is oxidized at the anode to form cations (protons) and electrons. The ion exchange membrane facilitates the migration of protons from the anode to the cathode. The electrons cannot pass through the membrane and are forced to flow through an external circuit, thus providing an electrical current. At the cathode, oxygen reacts at the catalyst layer, with electrons returned from the electrical circuit, to form anions. The anions formed at the cathode react with the protons that have crossed the membrane, to form liquid water as a reaction product.

Proton exchange membranes require a wet surface to facilitate the conduction of protons from the anode to the cathode, and otherwise to maintain the membrane's electrical conductivity. It has been suggested that each proton that moves through the membrane drags at least two or three water molecules with it (U.S. Pat. No. 5,996,976). U.S. Pat. No. 5,786,104 describes in more qualitative terms a mechanism termed “water pumping”, which results in the transport of cations (protons) with water molecules, through the membrane. As the current density increases, the number of water molecules moved through the membrane also increases. Eventually the flux of water being pulled through the membrane by the proton flux exceeds the rate at which water is replenished by diffusion. At this point the membrane begins to dry out, at least on the anode side, and its internal resistance increases. It will be appreciated that this mechanism drives water to the cathode side, and additionally the water created by the reaction is formed at the cathode side. Nonetheless, it is possible for the flow of gas across the cathode side to be sufficient to remove this water, resulting in drying out on the cathode side as well. Accordingly, the surface of the membrane must remain moist at all times. Therefore, to ensure adequate efficiency, the process gases must have, on entering the fuel cell, appropriate humidity and temperature which are based on the system requirements.

A further consideration is that there is an increasing interest in using fuel cells in transport and like applications, e.g. as the basic power source for cars, buses and even larger vehicles. Automotive applications are quite different from many stationary applications. For example, in stationary applications fuel cell stacks are commonly used as an electrical power source and are simply expected to run at a relatively constant power level for an extended period of time. In contrast, in an automotive environment, the actual power required from the fuel cell stack can vary widely. Additionally, the fuel cell stack supply unit is expected to respond rapidly to changes in power demand, whether these be demands for increased or reduced power, while maintaining high efficiencies. Further, for automotive applications, a fuel cell power unit is expected to operate under an extreme range of ambient temperature and humidity conditions.

All of these requirements are exceedingly demanding and make it difficult to ensure that a fuel cell stack will operate efficiently under all the possible ranges of operating conditions. While the key issues are ensuring that a fuel cell power unit can always supply a high power level and at a high efficiency and simultaneously ensuring that it has a long life, accurately controlling humidity levels within the fuel cell power unit is necessary to meet these requirements. More particularly, it is necessary to control humidity levels in both the oxidant and fuel gas streams. Most known techniques of humidification are poorly designed to respond to rapidly changing conditions, temperatures and the like. Many known systems can provide inadequate humidification. levels and may have high thermal inertia and/or large dead volumes, so as to render them incapable of rapid response to changing conditions.

For example, a fuel cell gas management system is disclosed in U.S. Pat. No. 6,013,385. The system comprises: a first reactant humidification subsystem for supplying a first reactant inlet stream to the first reactant inlet of the fuel cell and receiving a first reactant exhaust stream from the first reactant outlet of the fuel cell. Said first reactant humidification subsystem comprises an enthalpy wheel for collecting moisture from the first reactant (oxidant) exhaust stream and transferring a portion of the collected moisture to the first reactant inlet stream. A second reactant (fuel) humidity retention subsystem comprises a recirculation loop for collecting excess second reactant from the second reactant outlet of the fuel cell, a source of second reactant mixing means for mixing second reactant from a reactant source with second reactant collected from the second reactant outlet of the fuel cell and motive means for circulating second reactant in said recirculation loop and for introducing second reactant into the second reactant inlet of the fuel cell. However, this patent still fails to fully utilize the waste humidity from fuel cell exhaust. The fuel humidity retention subsystem is complicated and needs additional devices, which is not desirable for a compact fuel cell configuration.

There remains a need for a fuel cell humidification system that can offer rapid dynamic control of relative humidity for incoming fuel cell process gases in order to provide sufficient humidity over a wide variety of flow rates, for both the oxidant and fuel systems.

### SUMMARY OF THE INVENTION

One object of the present invention is to provide a fuel cell system for humidifying streams of first and second reactants of a fuel cell.

In accordance with one aspect of the present invention there is a fuel cell system provided for humidifying a cathode and an anode of a fuel cell through respective streams of first and second reactants, the fuel cell having at least a first reactant inlet, a first reactant outlet, a second reactant inlet and a second reactant outlet. The system comprises a cathode humidification subsystem, an anode humidity retention subsystem and a countercurrent flow arrangement of the fuel cell. The cathode humidification subsystem supplies a first reactant inlet stream to the first reactant inlet of the fuel cell and receives a first reactant exhaust stream from the first reactant outlet of the fuel cell. The cathode humidification subsystem includes a device for collecting moisture from at least a portion of the first reactant exhaust stream and transferring a portion of the collected moisture to the first reactant inlet stream. The anode humidity retention subsystem includes a recirculation loop for collecting an excess amount of the second reactant from the second reactant outlet of the fuel cell, a source of the second reactant and a device for mixing the second reactant from the source and the second reactant collected from the second reactant outlet of the fuel cell to form a second reactant inlet stream in the recirculation loop. The anode humidity retention subsystem further includes a motive device for circulating the second reactant in the recirculation loop and for introducing the second reactant inlet stream into the second reactant inlet of the fuel cell. The countercurrent flow arrangement of the fuel cell enables conduction of a countercurrent of the first and second reactant streams within the fuel cell, thereby enhancing water diffusion from the first reactant stream across a membrane electrode assembly of the fuel cell.

The countercurrent flow arrangement preferably comprises an open-faced continuous first reactant flow passage defined in a first reactant field plate in fluid communication with the first reactant inlet and outlet, and an open-faced continuous reactant flow passage defined in a second reactant field plate in fluid communication with the second reactant inlet and outlet. The first and second reactant field plates are positioned at opposite sides of the membrane electrode assembly and the first and second reactant flow passages preferably align with each other in a substantial length thereof, an upstream section of the first reactant flow passage coinciding with a downstream section of the second reactant flow passage.

Each of the flow passages preferably comprises at least one primary channel and a plurality of branch channels in parallel connection with each other and with the primary channel.

In accordance with another aspect of the present invention, there is a method provided for humidifying a cathode and an anode of a fuel cell through respective streams of first and second reactants, the fuel cell having at least a first reactant inlet, a first reactant outlet, a second reactant inlet and a second reactant outlet, which comprises: (a) collecting moisture from a first reactant exhaust stream exiting from the first reactant outlet and transferring at least a portion of the collected moisture to a first reactant inlet stream for introduction to the first reactant inlet; (b) collecting an excess amount of the second reactant from the second reactant outlet and mixing same with a supply of the second reactant from an external source to form a mixture of the second reactant; (c) circulating the mixture of the second reactant as a second reactant inlet stream for introduction to the second reactant inlet; and (d) transferring water from the first reactant stream across a membrane electrode assembly by means of water diffusion.

The method preferably further comprises the step of controlling operation of an enthalpy shifting device for directly regulating a moisture content of the first reactant inlet stream to regulate humidification of the cathode of the fuel cell and thereby to control the water diffusion from the first reactant stream across the membrane electrode assembly, resulting in further control of humidification of the anode of the fuel cell.

It is further preferable to regulate a pressure differential between a first reactant supply and a second reactant supply, which is conducted, for example, by control of the pressure of the second reactant supply using a pressure regulator actuated by pressure changes of the first reactant supply.

The present invention advantageously provides a fuel cell humidification system having combined the features derived from various humidification methods to achieve an efficient humidification of both cathode and anode streams, with a relatively simple implementation, which is particularly beneficial to small fuel cells. The present invention further advantageously provides a simple method for controlling humidification of both the anode and cathode of a fuel cell. All these features are particularly desirable for vehicular applications.

### BRIEF DESCRIPTION OF THE DRAWINGS

For a better understanding of the present invention, and to show more clearly how it may be carried into effect, reference will now be made, by way of example, to the accompanying drawings, which show a preferred embodiment of the present invention and in which:

FIG. 1 is a schematic diagram illustrating a fuel cell gas management system of the present invention, according to a preferred embodiment thereof;

FIG. 2 is a schematic diagram illustrating a preferred embodiment of the cathode humidification system of the present invention in greater detail;

FIG. 3 is a schematic diagram illustrating a preferred embodiment of the anode humidity retention subsystem of the present invention in greater detail;

FIG. 4 illustrates a schematic view of a cathode flow field plate defining an open-faced continuous passage having a plurality of primary channels each with a plurality of branch channels in parallel connections;

FIG. 5 illustrates a schematic view of the cathode flow fuel plate of FIG. 4 together with an anode flow field plate positioned at opposed sides of a membrane electrode assembly (not shown), defining in phantom lines, an open-faced continuous passage having a plurality of primary channels each with a plurality of branch channels in parallel connections, in which the passages in the cathode and anode flow field plates substantially coincide; and

FIG. 6 illustrates a schematic and sectional view of the fuel cell according to the preferred embodiment of the present invention illustrated in FIG. 5.

### DETAILED DESCRIPTION OF THE PREFERRED EMBODIMENTS

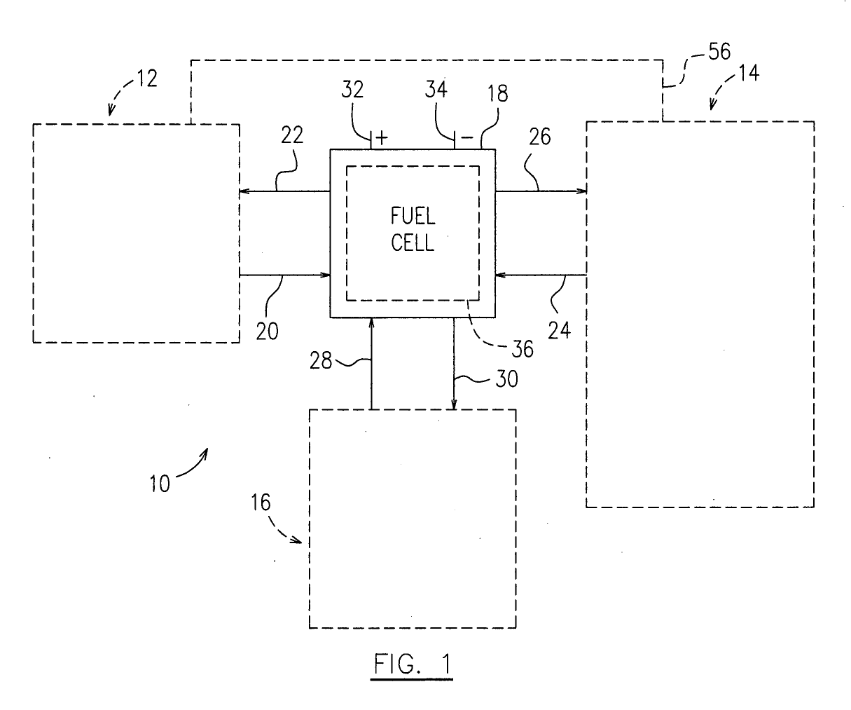

FIG. 1 illustrates a fuel cell gas management system 10 of the present invention, according to one preferred embodiment. The gas management system 10 generally comprises a cathode humidification system 12, a anode humidity retention system 14 and a cooling water processing system 16, all connected to a fuel cell 18. The fuel cell 18 generally comprises a cathode stream inlet 20, a cathode stream outlet 22, an anode stream inlet 24, an anode stream outlet 26, a cooling water inlet 28 and a cooling water outlet 30. Electricity generated by the fuel cell 18 is conducted to a load (not shown) by conductors 32 and 34. The fuel cell 18 can be used to supply electrical power for a variety of applications. For example, the fuel cell 18 can be used to recharge the batteries of an electric automobile or can be used as a power source for commercial or household electrical services.

The fuel cell 18 generally operates according to known methods, and may be any one of a number of known fuel cell varieties. In the described embodiment, the fuel cell will be described as a proton exchange membrane (PEM) fuel cell. However, the present invention is not so limited, and may be applied to the reactant streams of other types of fuel cells as well. In a typical proton exchange membrane fuel cell, hydrogen is supplied to the fuel cell's anode stream inlet 24, for use as the fuel, and air is supplied to the cathode stream inlet 20 of the fuel cell 18 for use as the fuel cell's oxidant. Within the fuel cell 18 or a fuel cell stack, the oxidant and the fuel react to generate water and electrical power. Fuel and oxidant are passed through alternate layers (not shown) in the fuel cell stack, the layers being separated by catalyst membranes.

The cathode humidification system 12, the anode humidity retention system 14 and a countercurrent flow arrangement 36 of the fuel and oxidant streams within the fuel cell 18, in combination constitute a fuel cell humidification system of the present invention, which will be further described in detail below. The cooling water processing system 16 is conventional and not part of the present invention, and will therefore not be further described.

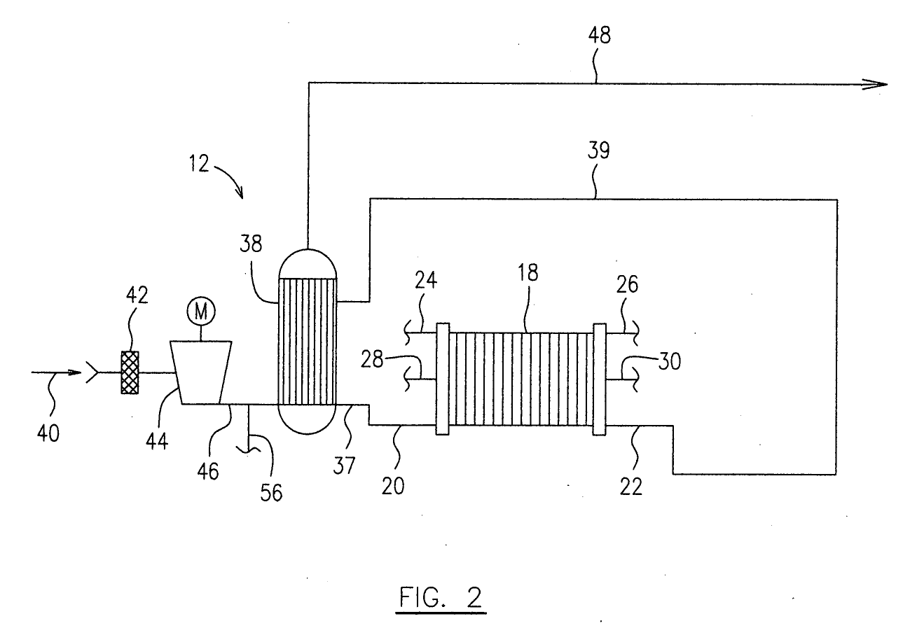

The cathode humidification system 12 is used for supplying a first reactant (such as an oxidant) inlet stream to the cathode stream inlet 20 (the first reactant inlet) of the fuel cell 18 and for receiving the cathode exhaust stream (the first reactant exhaust stream) from the cathode outlet 22 of the fuel cell 18. The cathode humidification system 12 includes a device (not shown) for collecting moisture from at least a portion of the oxidant exhaust stream and transferring a portion of the collected moisture to the oxidant inlet stream because the fuel cell 18 operates more efficiently at temperatures higher than room temperature, it is desirable to heat and humidify the oxidant air supplied to the cathode stream inlet 20 in order to prevent the cathode air stream from drying out the electrolytes in the fuel cell 18. This will be further described with reference to FIG. 2.

FIG. 2 illustrates the cathode humidification system 12 of FIG. 1 in greater detail. The cathode humidification system 12 includes a heat and moisture transferring device, preferably an enthalpy shifting device 38, for example, an enthalpy wheel which is well known in the art, connected to the cathode stream inlet 20 by a pipeline 37, and the cathode stream outlet 22 by a pipeline 39, respectively. Ambient air flow as indicated by arrow 40 is drawn preferably through a filter 42, such as an automotive air filter, and into a pressurization device, for example a motor driven compressor 44 which is connected by a pipeline 46 to the enthalpy shifting device 38. The compressed air flow is used for supply of an oxidant inlet stream and is directed through a pipeline 46 into the enthalpy shifting device 38 and further through pipeline 37, to the cathode stream inlet 20 of the fuel cell 18.

During operation of the fuel cell 18, water as a byproduct of the fuel cell operation, is produced at the cathode and collected in the fuel cell 18. The collected water with oxygen depleted air, mainly nitrogen gas which is part of the compressed ambient air flow 40 introduced into the fuel cell 18 and does not participate in the electrochemical reaction in the fuel cell 18, is discharged from the cathode stream outlet 22 of the fuel cell 18 as the cathode exhaust stream. The liquid water contained in the cathode exhaust stream discharged from the cathode stream outlet 22, may be separated from the gas portion (substantially nitrogen) of the cathode exhaust stream and collected, for example, in a water tank (not shown) which can be used for the cooling water processing system 16 of FIG. 1. The gas portion of the cathode exhaust stream which is discharged from the cathode stream outlet 22, is saturated with moisture. The saturated cathode exhaust from the cathode stream outlet 22 is directed through the pipeline 39 into the enthalpy shifting device 38 and further discharged into the atmosphere as non-combustible exhaust through a pipeline 48 which is connected to the enthalpy shifting device 38 and leads to the environment. In addition, instead of being separated and collected, the liquid water from the cathode exhaust stream may also be carried by the exhaust stream into the enthalpy shifting device 38. The enthalpy shifting device 38, therefore transfers sensible and latent heat from the cathode exhaust stream (air exhaust stream from the cathode stream inlet 22) to the cathode inlet stream (the compressed air stream to the cathode stream inlet 20), thereby achieving a moisture transfer therebetween.

Enthalpy shifting devices are well known in the art. Generally, the enthalpy shifting device 38 comprises porous materials, optionally with a desiccant, and is arranged for simultaneous countercurrent flow of a dry gas stream and a moisture saturated gas stream, with each flow passing through a separate part thereof. The enthalpy shifting device 38 further includes a switching means (not shown) to allow gases from the dry gas stream and the moisture saturated gas stream to alternately pass through different parts of the enthalpy shifting device 38 and to thereby exchange heat and humidity.

For example, the enthalpy shifting device 38 can be configured as an enthalpy wheel comprising a porous material coated with a water selective molecular sieve desiccant or zeolite and being driven by a variable speed electric motor. The moisture saturated cathode exhaust stream from the cathode stream outlet 22 is directed by the pipeline 39 through a first side of the enthalpy wheel where sensible and latent heat are collected by the enthalpy wheel as the cathode exhaust stream passes therethrough. As the enthalpy wheel rotates, this sensible and latent heat is released into the dry air inlet stream being supplied to the cathode stream inlet 20. However, other types of enthalpy shifting devices can be used, such as two or more beds or towers of zeolites with flow controlling valve means.

Sensors such as relative humidity sensors (not shown), temperature sensors (not shown) and pressure sensors (not shown) are preferably and conventionally provided for monitoring the conditions of the stream flow in the cathode humidification system 12. Valves or other conventional flow devices (not shown) are also preferably provided. Therefore, a feedback control system (not shown) is enabled to control the dry bulb temperature and relative humidity of the cathode inlet air stream.

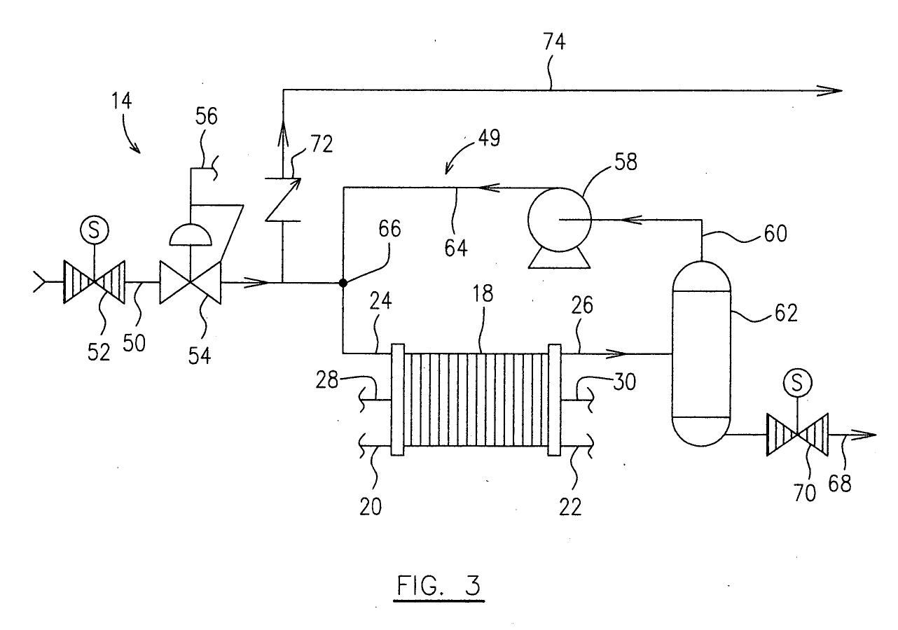

FIG. 3 schematically illustrates the anode humidity retention system 14 of FIG. 1 in greater detail. The anode humidity retention system 14 includes a recirculation loop 49 for collecting a significant portion of hydrogen exhaust (the anode exhaust stream) from the anode stream outlet 26 to mix with a source of hydrogen to form a hydrogen inlet stream (anode inlet stream) being introduced into the anode stream inlet 24 of the fuel cell 18.

The source of hydrogen can be any type of hydrogen gas supply, such as stored in pressurized container (not shown), and is introduced through pipeline 50 into the anode stream inlet 24 of the fuel cell 18. The pipeline 50 preferably comprises a normally closed solenoid valve 52 such that the fuel cell 18 is operated only when the solenoid valve 52 is actuated to open allowing for hydrogen gas supply. Pipeline 50 further preferably includes a flow regulating device 54 positioned downstream of the solenoid valve 52. The flow regulating device 54 permits the flow of the hydrogen stream from the hydrogen source to the fuel cell 18 in response to the pressure drop of the hydrogen gas supply in pipeline 50. The flow regulating device 54 may be a forward pressure regulator having a set point and permitting hydrogen gas to be supplied to the fuel cell 18 when the pressure of the hydrogen gas in pipeline 50 falls below the set point due to the hydrogen consumption in the fuel cell 18. This flow regulating device 54 avoids the need for an expensive mass flow controller and provides more rapid response and accurate flow control.

The flow regulating device 54 is preferably actuated by pressure changes in the compressed air stream in pipeline 46 of FIG. 2, which is achieved by means of a controlling pipeline 56 extending between the flow regulating device 54 and pipeline 46 of FIG. 2, for fluid communication therebetween. Therefore, the set point of the flow regulating device 54 can be automatically adjusted in response to the pressure changes in the air stream in pipeline 46 of FIG. 2, thereby substantially maintaining a desirable pressure differential between the air stream in the cathode stream humidification system 12 and the hydrogen stream in the anode stream humidity retention system 14, and providing an optimum condition for operation of the fuel cell 18.

The recirculation loop 49 of the anode humidity retention system 14, includes a hydrogen recirculation pump 58 as a recirculation motive device connected at an inlet end thereof to the anode stream outlet 26 of the fuel cell 18, through a pipeline 60 and a vessel 62. The hydrogen recirculation pump 58 at the outlet end thereof is connected through a pipeline 64 to pipeline 50 which extends to the anode stream inlet 24 of the fuel cell 18, by, for example a joint 66, which functions as a device for mixing the hydrogen exhaust (anode exhaust stream) from the anode stream outlet 26 of the fuel cell 18, with the hydrogen stream in pipeline 50 from the hydrogen gas source. However, any type of well known gas mixer can be used to replace the joint 66 for a similar function.

The hydrogen exhaust from the anode stream outlet 26 of the fuel cell 18, comprises excess hydrogen gas and water. The liquid water is collected in the vessel 62 at the bottom thereof, and can periodically be drained through pipeline 68, controlled by a solenoid valve 70. The excess hydrogen with water vapor in the hydrogen exhaust is pumped by the hydrogen recirculation pump 58, through the recirculation loop 49.

Recirculation of the excess hydrogen together with water vapor not only permits utilization of the hydrogen to the greatest possible extent and prevents liquid water from blocking hydrogen reactant delivery to the reactant sites within the fuel cell 18, but also achieves self-humidification of the fuel streams as the water vapor from the recirculated hydrogen humidifies the hydrogen inlet stream into the anode stream inlet 24 of the fuel cell 18. This recirculation arrangement renders a conventional humidifier for the hydrogen inlet stream unnecessary in the present invention, which advantageously simplifies the entire fuel cell management system, and is beneficial for a compact configuration of a small fuel cell.

The humidity conditions required for the hydrogen inlet stream to the anode stream inlet 24 of the fuel cell 18, can be adjusted by appropriately selecting the hydrogen recirculation flow rate. For example, given a circumstance in which the fuel cell 18 requires one unit of hydrogen, hydrogen can be supplied from the hydrogen source in the amount of three units, with two units of excess hydrogen being recirculated together with the water vapor. The speed of pump 58 may be varied to adjust the portion of recirculated hydrogen in the mixture of hydrogen downstream of the joint 66.

In practice, since air is used as the oxidant, it has been found that nitrogen cross-over from the cathode side of the fuel cell 18 to the anode side can occur, through the membrane of a PEM fuel cell. Therefore, the hydrogen exhaust from the anode stream outlet 26 of the fuel cell 18 actually contains some nitrogen and possibly other impurities. Recirculation of the hydrogen exhaust could result in accumulation of nitrogen and poisoning of the fuel cell. The vessel 62 further comprises components (not shown) functioning as a purge control device to purge a portion of the hydrogen exhaust out of the recirculation loop 49, through pipeline 68. Said purge operation is controlled by the solenoid valve 70. The frequency and flow rate of the purge operation corresponds with and is dependent on the power level on which the fuel cell 18 is running. When the fuel cell 18 is running on high power, it is desirable to purge a high portion of hydrogen exhaust.

A relief valve 72 is provided with a hydrogen vent pipeline 74 which is connected to a section of pipeline 50 downstream of the flow regulating device 54 and upstream of the joint 66 in order to maintain a maximum safety pressure of the hydrogen stream in the anode humidity retention system 14. When the pressure in the system reaches the predetermined maximum safety level, the check valve 72 is opened for venting hydrogen gas which can then be collected and delivered to the hydrogen gas source for re-use (not illustrated).

Similar to the cathode humidification system 12 of FIG. 2, temperature and pressure sensors, flow regulating devices and transmitters are preferably included in the anode humidity retention system 14, and can be conventionally controlled by the fuel cell control system which controls the conditions for fuel cell operation. The control system preferably also controls solenoid valves 52 and 70 and the hydrogen exhaust recirculation pump 58.

Referring again to FIG. 1, in addition to the cathode humidification system 12 and the anode humidity retention system 14, the fuel cell humidification system of the present invention further includes the countercurrent flow arrangement 36 within the fuel cell 18 for further enhancing the humidification of the membrane of the fuel cell 18, particularly the anode side thereof.

As discussed in the Background of the Invention, when the flux of water being pulled through the membrane by proton flux exceeds the rate at which water is replenished by diffusion, the membrane begins to dry out, particularly on the anode side. To overcome this problem, measures must be taken to enhance the water diffusion from the fuel and oxidant streams towards and/or through the membrane of the fuel cell 18.

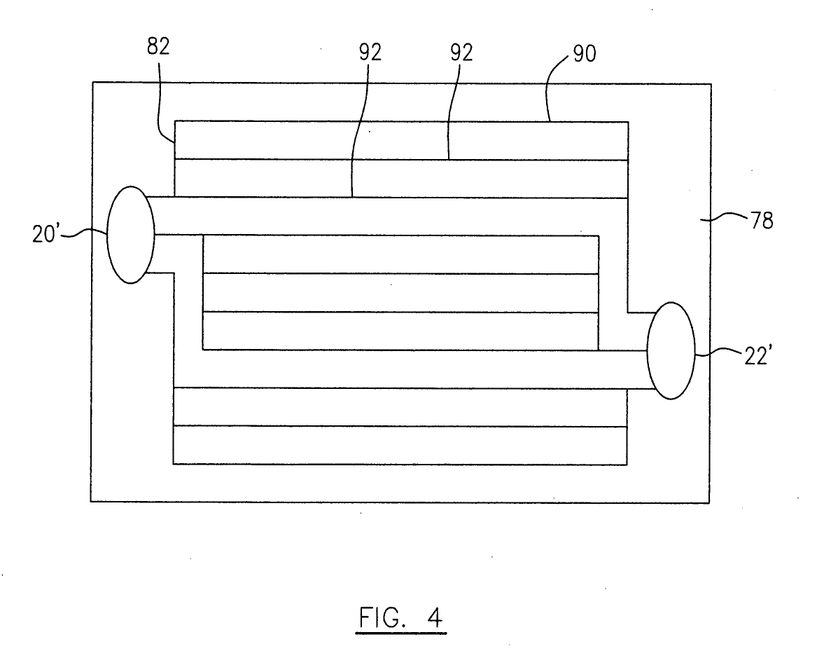

Referring to FIGS. 4, 5 and 6, the countercurrent flow arrangement 36 is designed for conducting countercurrent of the air stream and hydrogen stream within the fuel cell 18 of FIG. 1 in order to achieve water diffusion from the air stream across a membrane electrode assembly 76 (MEA) of the fuel cell 18.

The countercurrent flow arrangement 36 of the fuel cell 18 includes a cathode flow field plate 78, an anode flow field plate 80 positioned at opposed sides of the membrane electrode assembly (MEA) 76. Each reactant flow field plate 78, 80 has an inlet region 20′ or 24′, an outlet region 22′ or 26′, and an open-faced continuous passage 82 or 84 to connect the respective cathode and anode stream inlets 20, 24 in fluid communication with the cathode and anode stream outlets 22, 26, and provides a way of distributing the reactant streams to the outer faces of the MEA 76.

The MEA 76 includes a solid electrolyte which is a proton exchange membrane (not shown) disposed between a cathode catalyst layer (not shown) and the anode catalyst layer (not shown). A first gas diffusion media (GDM) 86 is disposed between the cathode catalyst layer and the cathode flow field plate 78. A second GDM 88 is disposed between the anode catalyst layer and the anode flow field plate 80. The GDMs 86, 88 facilitate the diffusion of reactant gas, either fuel or oxidant, to the catalyst surfaces of the MEA 76. Furthermore, the GDMs 86, 88 enhance the electrical conductivity between each of the cathode and anode flow field plates 78, 80 and the membrane of the MEA 76.

The open-faced continuous passage 82 defined in the cathode flow field plate 78, includes at least one primary channel 90 (there are three primary channels in this embodiment) and a plurality of branch channels 92 in parallel connection with each other and with the primary channel 90. Therefore, the open-faced continuous passage 82 is adapted to provide a relatively high flow rate for the air stream passing through the fuel cell 18 with a minimum pressure drop while providing an increased fluid contact area with respect to the GDM 86 to thereby facilitate the diffusion of both oxidant gas and water across the GDM 86 to the MEA 76.

The open-faced continuous passage 84 defined in the anode flow field plate 80 is configured similarly and will not be further described.

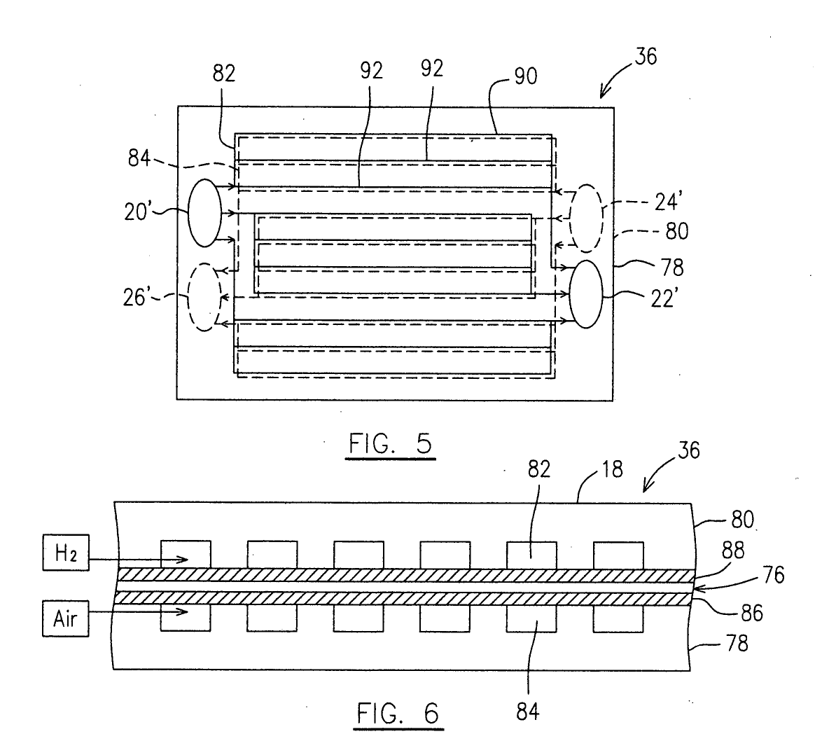

The open-faced continuous passages 82, 84 defined in the respective reactant flow field plates 78, 80 are shaped and located such that when the cathode and anode flow field plates 78, 80 are positioned at opposite sides of the MEA 76 (as shown in FIG. 6), the passages 82, 84 align with each other in a substantial length thereof with an upstream section thereof close to the inlet region 20′ of the passage 82 coinciding with a downstream section near the outlet regions 26′ of the passage 84 (see FIG. 5).

The branch channels 92 and a substantial length of the primary channel 90 of the passages 84 preferably align with the corresponding branch channels and a substantial length of the primary channels of the passage 84. For clear illustration, the branch channels and the substantial length of the primary channels of the respective passages 82, 84 are shown in the closely positioned parallel solid and broken lines, and are in fact superposed.

The open-faced continuous passages 82 and 84 are oriented to achieve countercurrent hydrogen and air flow streams. In other words, the hydrogen and air streams flow in generally opposite directions across the fuel cell 18. The water content of both the hydrogen and air streams increases in the flow direction of the respective reactant through the fuel cell 18. By employing a countercurrent flow arrangement 36, the region of the anode layer with the highest water content substantially coincides with the region of the cathode layer having the lowest water content, and vice versa. As a result, countercurrent reactant flow streams result in more uniform hydration of the MEA 76. Furthermore, a portion of the additional water produced at the cathode side, back-diffuses across the MEA 76 toward the anode side, which is facilitated by the alignment of the passages 82 and 84. The facilitated water back-diffusion from the cathode side to the anode side through the MEA 76 can be maintained at a rate exceeding the flux of water being pulled through the membrane by the proton flux such that the anode side of the MEA 76 is humidified not only by the moisture contained in the hydrogen stream flowing passage 82, but is also humidified by the moisture contained in the air stream flowing in passage 84.

It should be noted that the present invention does not simply aggregate the individual cathode humidification system and anode humidity retention system, but creates a fuel cell humidification system having the combined cathode humidification system, anode humidity retention system and a countercurrent flow arrangement of hydrogen and air streams within the fuel cell. The combination feature is achieved by the enhanced water back-diffusion from the cathode side to the anode side across the membrane in the countercurrent flow arrangement, to use the water content in the air stream to further humidify the anode side of the MEA 76. Furthermore, the cathode stream humidification system 12 and the anode stream humidity retention system 14 are combined by pipeline 56 (see FIG. 1) to achieve a pressure differential control between the two systems for optimum operative conditions of the fuel cell 18.

In the fuel cell humidification system of the present invention, the humidity of the anode can be determined as follows. Firstly, the flow rate of the hydrogen stream can be calculated based on the predetermined load. Secondly, the water transfer rate from the air stream across the membrane to the anode side thereof can be determined based on the information of load and cathode inlet humidity. Therefore, the humidity of the anode of the fuel cell can be calculated according to the above-determined information.

Because of the combined features of those systems, the present invention further advantageously provides a single step for controlling humidification of both the cathode and anode of the fuel cell 18, that is, by controlling operation of the enthalpy shifting device for directly regulating the moisture content of the cathode inlet stream (air stream) to regulate humidification of the cathode of the fuel cell and thereby to control the water diffusion from the air stream across the MEA 76, resulting in further control of humidification of the fuel cell 18. In the case of an enthalpy wheel, this single step for controlling humidification of both the cathode and anode of the fuel cell 18 can be achieved by controlling the speed of the enthalpy wheel operation.

it should be noted that individually and separately regulating the moisture content of either reactant streams within the fuel cell 18 is still possible in the system of the present invention, which is well known in the art.

It should also be noted that the cathode and anode flow field plates 78, 80 of FIG. 4-6 are schematically illustrated only to show the open-faced continuous passages 82, 84 defined therein respectively, and are not intended to represent particular configurations and structural details thereof. Cathode and anode flow field plates of any other types can be used for the present invention, provided that they define the respective continuous fluid passages in accordance with the principles described in this patent application

Modifications and improvements to the above-described embodiments of the present invention may become apparent to those skilled in the art. For example, the present invention could have applicability in various types of fuel cells. The foregoing description is intended to be exemplary rather than limiting. The scope of the present invention is therefore intended to be limited solely by the scope of the appended claims.

I/We claim:

1. A fuel cell system for humidifying a cathode and an anode of a fuel cell through respective streams of first and second reactants, the fuel cell having at least a first reactant inlet, a first reactant outlet, a second reactant inlet and a second reactant outlet, the system comprising:
a cathode humidification subsystem for supplying a first reactant inlet stream to the first reactant inlet of the fuel cell and receiving a first reactant exhaust stream from the first reactant outlet of the fuel cell, the cathode humidification subsystem including a device for collecting moisture from at least a portion of the first reactant exhaust stream and transferring a portion of the collected moisture to the first reactant inlet stream;
an anode humidity retention subsystem including a recirculation loop for collecting an excess amount of the second reactant from the second reactant outlet of the fuel cell, a source of the second reactant, a device for mixing the second reactant from the source with the second reactant collected from the second reactant outlet of the fuel cell to form a second reactant inlet stream in the recirculation loop, and a motive device for circulating the second reactant in the recirculation loop and for introducing the second reactant inlet stream into the second reactant inlet of the fuel cell; and
a countercurrent flow arrangement of the fuel cell for conducting a countercurrent of the first and second reactant streams within the fuel cell, thereby enhancing water diffusion from the first reactant stream across a membrane electrode assembly of-the fuel cell.

2. The fuel cell system as claimed in claim 1 wherein the countercurrent flow arrangement comprises an open-faced continuous first reactant flow passage defined in a first reactant field plate in fluid communication with the first reactant inlet and outlet, and an open-faced continuous second reactant flow passage defined in a second reactant field plate in fluid communication with the second reactant inlet and outlet, the first and second reactant field plates being positioned at opposite sides of the membrane electrode assembly and the first and second reactant flow passages aligning with each other in a substantial length thereof, a upstream section of the first reactant flow passage coinciding with a downstream section of the second reactant flow passage.

3. The fuel cell system as claimed in claim 2 wherein the first reactant flow passage comprises at least one primary channel and a plurality of branch channels in parallel connection with each other and with the primary channel, and wherein the second reactant flow passage comprises at least one primary channel and a plurality of branch channels in parallel connection with each other and with the primary channel.

4. The fuel cell system as claimed in claim 3 wherein the individual branch channels of the first reactant flow passage at one side of the membrane electrode assembly, align with the individual branch channels of the second reactant flow passage at the other side of the membrane electrode assembly, respectively.

5. The fuel cell system as claimed in claim 1 wherein the device for collecting moisture of the cathode humidification subsystem comprises an enthalpy shifting device.

6. The fuel cell system as claimed in claim 5 wherein the cathode humidification subsystem comprises a compressor located upstream of the enthalpy shifting device and in fluid communication with an external source of the first reactant to compress the first reactant for supplying the first reactant inlet stream to the first reactant inlet of the fuel cell through the enthalpy shifting device.

7. The fuel cell system as claimed in claim 1 wherein the motive device of the anode humidity retention subsystem comprises a fluid pump.

8. The fuel cell system as claimed in claim 1 further comprising means for regulating a pressure differential between the first and second reactant streams.

9. The fuel cell system as claimed in claim 6 wherein the source of the second reactant of the anode humidity retention subsystem comprises a pressure regulator operated by means of pressure changes of the compressed first reactant in the cathode humidification subsystem.

10. The fuel cell system as claimed in claim 1 wherein the anode humidity retention subsystem comprises a vent device for selectively venting combustible fluid accumulated in the recirculation loop.

11. The fuel cell system as claimed in claim 1 wherein the source of the second reactant of the anode humidity retention subsystem comprises a safety valve to maintain a predetermined maximum pressure of the second reactant to be mixed with the second reactant collected from the second reactant outlet of the fuel cell.

12. A method for humidifying a cathode and an anode of a fuel cell through respective streams of first and second reactants, the fuel cell having at least a first reactant inlet, a first reactant outlet, a second reactant inlet and a second reactant outlet, the method comprising:
(a) collecting moisture from a first reactant exhaust stream exiting from the first reactant outlet and transferring at least a portion of the collected moisture to a first reactant inlet stream for introduction to the first reactant inlet;
(b) collecting an excess amount of the second reactant from the second reactant outlet and mixing same with a supply of the second reactant from an external source to form a mixture of the second reactant;
(c) circulating the mixture of the second reactant as a second reactant inlet stream for introduction to the second reactant inlet; and
(d) transferring water from the first reactant stream across a membrane electrode assembly by means of water diffusion.

13. The method as claimed in claim 12 further comprising steps of directing the first and second reactant streams from the respective first and second reactant inlets to the respective first and second reactant outlets in a countercurrent flow arrangement within the fuel cell to enhance water diffusion from the first reactant stream across the membrane electrode assembly.

14. The method as claimed in claim 12 further comprising a step of controlling operation of an enthalpy shifting device for directly regulating a moisture content of the first reactant inlet stream to regulate humidification of the cathode of the fuel cell and thereby to control water diffusion from the first reactant stream across the membrane electrode assembly, resulting in further control of humidification of the anode of the fuel cell.

15. The method as claimed in claim 12 further comprising regulating a pressure differential between a first reactant supply and a second reactant supply.

16. The method as claimed in claim 15 wherein the regulation of the pressure differential is conducted by control of the pressure of the second reactant supply using a pressure regulator actuated by pressure changes of the first reactant supply.

17. The method as claimed in claim 12 further comprising a step of selectively venting combustible fluid accumulated in the second reactant stream.
